(19) United States
(12) Patent Application Publication
(10) Pub. No.: US 2025/0180839 A1
(43) Pub. Date: Jun. 5, 2025

(54) MULT-CHIP PACKAGE DESIGN MODULE OF GLASS V-GROOVE DESIGN WITHOUT CONVENTIONAL WIRE BONDING

(71) Applicant: Shenzhen 8k Link Optoelectronics Technology Co., Ltd., Shenzhen (CN)

(72) Inventors: Xinghui JIN, Shenzhen (CN); Yang LI, Shenzhen (CN)

(73) Assignee: Shenzhen 8k Link Optoelectronics Technology Co., Ltd., Shenzhen (CN)

(21) Appl. No.: 18/526,918

(22) Filed: Dec. 1, 2023

(51) Int. Cl. G02B 6/42

(52) U.S. Cl. CPC G02B 6/428; G02B 6/4215; G02B 6/4239; G02B 6/4243; G02B 6/4259

(57) ABSTRACT

A multi-chip package design module includes a first circuit board and a multi-chip package. The multi-chip package is installed on a top portion of the first circuit board; the multi-chip package includes a second circuit board; an optical chip is welded to a top portion of the second circuit board; the multi-chip package further includes a drive chip welded to the second circuit board; the drive chip and the optical chip are externally and fixedly provided with an epoxy molding compound; and the multi-chip package further includes two power supply pins fixedly connected to a bottom portion of the second circuit board. The application combines the multi-chip package with a glass V-groove design to omit conventional COB and coupling processes, which can simplify and standardize a product structure.

### TECHNICAL FIELD

The application relates to the technical field of multi-chip packages, and in particular, to a multi-chip package design module of a glass V-groove design without conventional wire bonding.

### BACKGROUND

With the improvement of the design and process conditions for silicon-based photonic integration, an optical module formed by various types of active or inactive devices and their combinations on a chip has been able achieve good signal processing in a small size at present. A complete optical communication link is often composed of three parts, including “an emitter—a transmission medium—a receiver”, and the optical signal processing on the integrated chip is still implemented by a conventional optical fiber structure as the transmission medium. Therefore, it is a matter of concern how to achieve the high-efficiency coupling of medium-frequency waves between the chip and the optical fibers to ensure the signal transmission quality of the communication link.

When an existing chip is coupled with an optical fiber, the coupling is difficult due to an excessive gap in sectional size between the optical fiber and a silicon-based single-mold waveguide, because the core diameter of the single-mode optical fiber is 10 μm and the sectional size of the silicon-based single-mold waveguide is 500 nm×220 nm. If the two are directly docked and coupled, there will be a very large coupling loss. Furthermore, the coupling process is complex, and the fiber threading process is difficult, requiring a higher technical level.

### SUMMARY

The application provides a multi-chip package design module of a glass V-groove design without conventional wire bonding, in order to solve the above defects in the prior art.

To achieve the above object, the application employs the following technical solutions: a multi-chip package design module of a glass V-groove design without conventional wire bonding includes a first circuit board and a multi-chip package, wherein the multi-chip package is installed on a top portion of the first circuit board, the multi-chip package includes a second circuit board, an optical chip is welded to a top portion of the second circuit board, and the multi-chip package is based on a multi-chip package technology instead of a conventional Chip On Board (COB) process, such that die bonding and wire bonding are omitted, which saves the process time to allow rapid switching of products and thus facilitate the production; and a transmission mechanism, wherein the transmission mechanism is installed on the top portion of the first circuit board, the transmission mechanism includes a glass block fixedly connected to the top portion of the first circuit board, a top portion of the glass block is provided with a plurality of V-grooves, in which optical fibers are fixed, and gratings are etched in outer portions of the optical fibers. The coupling is implemented using the gratings, thereby achieving light weight, small size, electromagnetic interference resistance, ready availability for optical fiber connection, and absolutely encoded wavelength; moreover, a plurality of sensors can be connected into a sensor network by using various complexing technologies, and then embedded inside a material and structure or mounted on their surfaces to achieve multi-point monitoring of properties (such as temperature and strain) of the material and structure; and the glass V-grooves are used to fix the optical fibers, which can omit the conventional fiber threading process to make the processing and production more convenient and faster.

Further, the multi-chip package further includes a drive chip welded to the second circuit board, and the drive chip and the optical chip are externally and fixedly provided with an epoxy molding compound. The second circuit board, the drive chip and the optical chip form the multi-chip package, which is an integrated chip. The integration of chips can improve the precision of chips and omit the DB/WB process to improve the production efficiency and consistency.

Further, the multi-chip package further includes two power supply pins fixedly connected to a bottom portion of the second circuit board, and the two power supply pins are connected to the first circuit board via welding. The power supply pins are arranged on the chips, such that the process and structure of the conventional copper wire bonding can be omitted; and the power is directly supplied in an optical fiber coating form to directly power the chip to drive the module to work.

Further, the multi-chip package further includes a Vcsel laser fixedly connected to a top portion of the optical chip, the optical chip being electrically connected to the Vcsel laser. The V-grooves and the Vcsel laser are positioned on the same plane, such that device coupling can be omitted to save the cost.

Further, the transmission mechanism further includes a cover plate fixedly connected to the top portion of the glass block.

Further, the cover plate is connected to the glass block by means of adhesive dispensing, the optical fibers are connected to the glass block by means of adhesive dispensing, and a bottom portion of the glass block is connected to the second circuit board by means of adhesive dispensing. By means of the gratings, the cover plate is directly pressed on the V-grooves, making optical transmission losses smaller.

Further, the multi-chip package is externally and fixedly provided with a housing, which is provided with a plurality of optical fiber openings at one side, and the optical fibers are inserted in the optical fiber openings.

Compared with the prior art, the application has the following beneficial effects.

In the application, the multi-chip package installed is based on the multi-chip package technology instead of the conventional COB process, which omits die bonding and wire bonding and saves the process time, and products can be rapidly switched to facilitate the production.

In the application, the transmission mechanism installed is coupled by using gratings, thereby achieving light weight, small size, electromagnetic interference resistance, ready availability for optical fiber connection, and absolutely encoded wavelength; moreover, a plurality of sensors can be connected into a sensor network by using various complexing technologies, and then embedded inside a material and structure or mounted on their surfaces to achieve multi-point monitoring of properties (such as temperature and strain) of the material and structure; and the glass V-grooves are used to fix the optical fibers, which can omit the conventional fiber threading process to make the processing and production more convenient and faster.

In summary, the module has a novel design with simple operation; the module combines the multi-chip package with the glass V-groove design to omit conventional COB and coupling processes, which can simplify and standardize a product structure; and moreover, the use of the multi-chip package and the glass V-groove design can eliminate the complexity of the conventional coupling process to make a fiber threading process simpler, and can also reduce the cost of individual devices.

### BRIEF DESCRIPTION OF THE DRAWINGS

FIG. 1 is a schematic diagram showing a first overall stereostructure of a multi-chip package design module of a glass V-groove design without conventional wire bonding according to the application.

FIG. 2 is a schematic diagram showing a first stereostructure inside a housing of a multi-chip package design module of a glass V-groove design without conventional wire bonding according to the application.

FIG. 3 is a schematic diagram showing a second stereostructure inside a housing of a multi-chip package design module of a glass V-groove design without conventional wire bonding according to the application.

FIG. 4 is a schematic diagram showing, in a top view, a structure of a multi-chip package design module of a glass V-groove design without conventional wire bonding according to the application.

FIG. 5 is a schematic diagram showing, in a side view, a structure of a multi-chip package design module of a glass V-groove design without conventional wire bonding according to the application.

FIG. 6 is a schematic diagram showing a second overall stereostructure of a multi-chip package design module of a glass V-groove design without conventional wire bonding according to the application.

### DETAILED DESCRIPTION OF THE EMBODIMENTS

The technical solutions in the embodiments of the application will be described clearly and completely below in conjunction with the accompanying drawings in the embodiments of the application. Obviously, the embodiments described are merely some instead of all of the embodiments of the application.

In the description of the application, it should be understood that terms such as “upper”, “lower”, “front”, “back”, “left”, “right”, “top”, “bottom”, “inside”, “outside” and the like indicate direction or position relations based on the direction or position relations as shown in the accompanying drawings only for the purpose of describing the application and simplifying the description, instead of indicating or implying that a device or element referred to must have a specific direction or must be constructed and operated in a specific direction. Therefore, these terms should not be construed as limiting the application.

### Embodiment 1

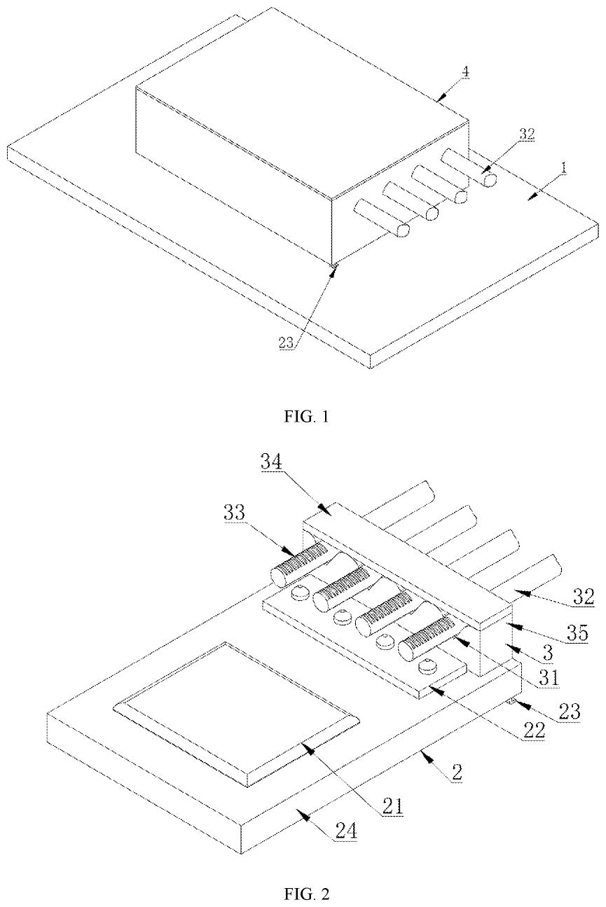

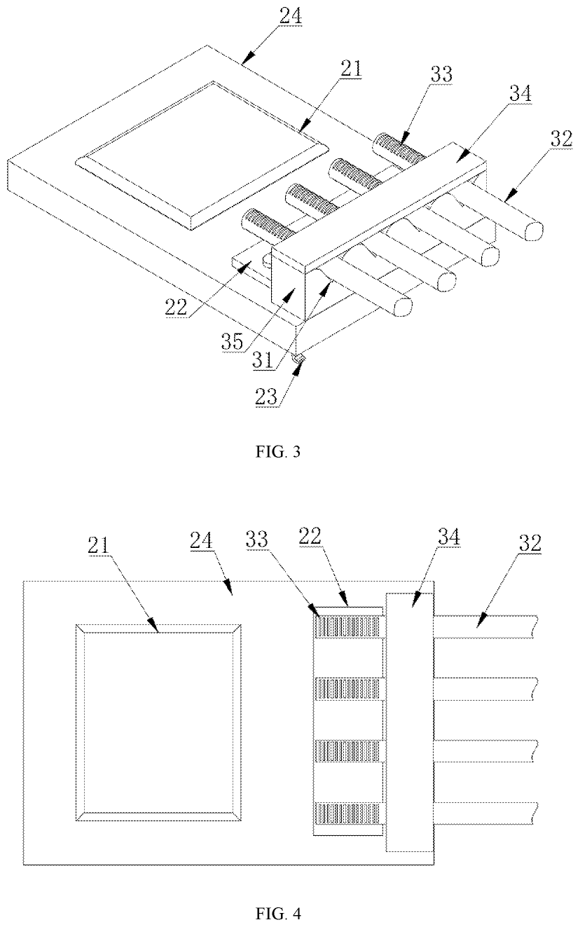

Referring to FIGS. 1-3, a multi-chip package design module of a glass V-groove design without conventional wire bonding includes: a first circuit board 1 and a multi-chip package 2, where the multi-chip package 2 is installed on a top portion of the first circuit board 1, the multi-chip package 2 includes a second circuit board 24, an optical chip 22 is welded to a top portion of the second circuit board 24; and the multi-chip package 2 is based on a multi-chip package technology instead of a conventional COB process, such that die bonding and wire bonding are omitted, which saves the process time to allow rapid switching of products and thus facilitate the production.

And a transmission mechanism 3, where the transmission mechanism 3 is installed on the top portion of the first circuit board 1, the transmission mechanism 3 includes a glass block 35 fixedly connected to the top portion of the first circuit board 1, a top portion of the glass block 35 is provided with a plurality of V-grooves 31, in which optical fibers 32 are fixed, and gratings 33 are etched in outer portions of the optical fibers 32. The coupling is implemented using the gratings 33, thereby achieving light weight, small size, electromagnetic interference resistance, ready availability for optical fiber connection, and absolutely encoded wavelength; moreover, a plurality of sensors can be connected into a sensor network by using various complexing technologies, and then embedded inside a material and structure or mounted on their surfaces to achieve multi-point monitoring of properties (such as temperature and strain) of the material and structure; and the glass V-grooves are used to fix the optical fibers, which can omit the conventional fiber threading process to make the processing and production more convenient and faster.

The multi-chip package 2 further includes a drive chip 21 welded to the second circuit board 24, and the drive chip 21 and the optical chip 22 are externally and fixedly provided with an epoxy molding compound. The second circuit board 24, the drive chip 21 and the optical chip 22 form the multi-chip package, which is an integrated chip. The integration of chips can improve the precision of chips and omit the DB/WB process to improve the production efficiency and consistency.

The multi-chip package 2 further includes two power supply pins 23 fixedly connected to a bottom portion of the second circuit board 24, and the two power supply pins 23 are connected to the first circuit board 1 via welding. The power supply pins 23 are arranged on the chips, such that the process and structure of the conventional copper wire bonding can be omitted; and the power is directly supplied in an optical fiber coating form to directly power the chip to drive the module to work.

The multi-chip package 2 further includes a Vcsel laser fixedly connected to a top portion of the optical chip 22, the optical chip 22 being electrically connected to the Vcsel laser. The V-grooves 31 and the Vcsel laser are positioned on the same plane, such that device coupling can be omitted to save the cost.

### Embodiment 2

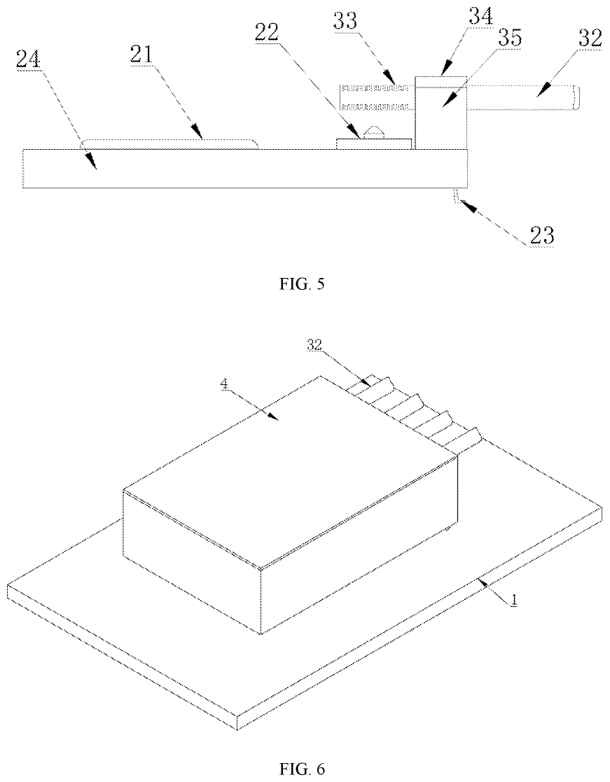

Referring to FIGS. 2-6, this embodiment provides a technical solution based on Embodiment 1 as follows.

The transmission mechanism 3 further includes a cover plate 34 fixedly connected to the top portion of the glass block 35.

The cover plate 34 is connected to the glass block 35 by means of adhesive dispensing, the optical fibers 32 are connected to the glass block by means of adhesive dispensing, and a bottom portion of the glass block 35 is connected to the second circuit board 24 by means of adhesive dispensing. By means of the gratings 33, the cover plate 34 is directly pressed on the V-grooves, making optical transmission losses smaller.

The multi-chip package 2 is externally and fixedly provided with a housing 4, which is provided with a plurality of optical fiber openings at one side, and the optical fibers are inserted in the optical fiber openings.

Working principle: The optical fibers 32 are directly docked with a light-emitting plane of the Vcsel laser by means of the gratings 33; the light emitted by the Vcsel laser is directly refracted into the optical fibers 32, such that optical articles Lens and Jumper are omitted; and the multi-chip package is powered by the power supply pins 23, such that the wire bonding for conventional copper wires is omitted, making it possible to endow the module of the application with smaller size and stronger electromagnetic interference resistance.

The description above only provides the preferred embodiments of the application, but is not intended to limit the protection scope of the application. Any equivalent substitutions or variations made according to the technical solutions and inventive conception of the application by those skilled in the art within the technical scope disclosed by the application shall be construed as falling within the protection scope of the application.

What is claimed is:

1. A multi-chip package design module of a glass V-groove design without conventional wire bonding, comprising:
a first circuit board;
a multi-chip package installed on a top portion of the first circuit board, wherein the multi-chip package comprises a second circuit board, and an optical chip is welded to a top portion of the second circuit board; and
a transmission mechanism installed on the top portion of the first circuit board, wherein the transmission mechanism comprises a glass block fixedly connected to the top portion of the first circuit board, a top portion of the glass block is provided with a plurality of V-grooves, in which optical fibers are fixed, and gratings are etched in outer portions of the optical fibers.

2. The multi-chip package design module according to claim 1, wherein the multi-chip package further comprises a drive chip welded to the second circuit board, and the drive chip and the optical chip are externally and fixedly provided with an epoxy molding compound.

3. The multi-chip package design module according to claim 1, wherein the multi-chip package further comprises two power supply pins fixedly connected to a bottom portion of the second circuit board, and the two power supply pins are connected to the first circuit board via welding.

4. The multi-chip package design module according to claim 1, wherein the multi-chip package further comprises a Vcsel laser fixedly connected to a top portion of the optical chip, the optical chip is electrically connected to the Vcsel laser.

5. The multi-chip package design module according to claim 1, wherein the transmission mechanism further comprises a cover plate fixedly connected to the top portion of the glass block.

6. The multi-chip package design module according to claim 5, wherein the cover plate is connected to the glass block by means of adhesive dispensing, the optical fibers are connected to the glass block by means of adhesive dispensing, and a bottom portion of the glass block is connected to the second circuit board by means of adhesive dispensing.

7. The multi-chip package design module according to claim 1, wherein the multi-chip package is externally and fixedly provided with a housing, which is provided with a plurality of optical fiber openings at one side, and the optical fibers are inserted in the optical fiber openings.
